(19) United States
(12) Patent Application Publication
(10) Pub. No.: US 2010/0133166 A1
(43) Pub. Date: Jun. 3, 2010

(54) COMPOSITE WATER PERMEABLE BRICK AND COMPOSITION FOR PRODUCING THE SAME

(75) Inventors: Shengyi Qin, Haidian District (CN); Weimin Zhang, Haidian District (CN)

Correspondence Address: OCCHIUTI ROHLICEK & TSAO, LLP, 10 FAWCETT STREET, CAMBRIDGE, MA, 02138, US

(73) Assignee: BEIJING RECHSAND SCIENCE & TECHNOLOGY GROUP CO., L, Beijing (CN)

(21) Appl. No.: 12/443,657

(22) PCT Filed: Sep. 29, 2007
(86) PCT No.: PCT/CN07/02868

§ 371 Date: Jan. 13, 2010

(30) Foreign Application Priority Data
Sep. 30, 2006 (CN) 200610140628.7

(51) Int. Cl. B01D 24/02; C09D 1/00; C08K 3/00; C08K 3/36; E02B 11/00

(52) U.S. Cl. 210/290; 106/286.8; 523/466; 524/590; 524/556; 405/45

(57) ABSTRACT

The invention disclosed a composite permeable brick comprising a permeable surface layer and a permeable base layer. The surface layer and the permeable base layer, which respectively comprise an aggregate and a binder adhering to the aggregate, are closely combined together. The binder in the permeable surface layer at least comprises a hydrophilic binder. The permeable brick according to the invention has a good permeability and is of low cost, because of the compact and permeable surface of the brick. The invention also discloses a mixture for preparing the composite permeable brick, comprising an aggregate and a binder adhering to the aggregate. The binder at least comprises a hydrophilic binder, and the binder/aggregate ratio is from 1:100 to 20:100 by mass. The composite permeable brick and the mixture of the invention may be used for road surfacing, water circulation, water filtration and water purification, promoting the full utilization of rainwater resources and improving the urban water circulation.

### FIELD OF THE INVENTION

This invention relates to a permeable building material, more particularly, to a permeable brick with good permeability in fields such as construction materials, rainwater collection, water filtration and purification, and a mixture for preparing such permeable articles.

### BACKGROUND ART

At present, owing to the worldwide shortage of energy and water resources, expansion of desertification area and the frequent occurrence of sand storm, the living environment of human being is deteriorating day by day. Presently the urban residential areas are primarily surrounded by urban squares, commercial streets, pavements, areas for community activities, parking lots and the like, of which the ground is road surfaces are paved with impermeable materials such as grantie, marble, cement, and asphalt. Such hardened ground is greatly detrimental to the urban environment. When it rains, because the hardened ground completely prevents the rainwater from directly sinking into the earth, the stagnant water makes it inconvenient for people to go outside, and finally the precious water resources run off through the drain pipes, thus imposing a heavy burden on urban drainage facilities; due to the mass running off of rainwater, the groundwater table is difficult to rise again and this directly influences the health of urban vegetation so that it is difficult for ground plants to grow normally and the burden on municipal greening is increased; the mass running of rainwater further aggravate the problems of drought and water scarcity. Thus it is imperative to develop new environmentally-friendly building materials and improve and beautify the living environment of human being.

Some permeable bricks and the permeable materials used in permeable pavements and the like available in the current construction material markets are primarily made of ceramic or concrete. The production of ceramic permeable brick needs a great quantity of mineral resources as raw materials, the expoitation of which damages environment. The production process of ceramic permeable brick is complicated, and it takes considerable energy to sinter and mold ceramic substrate brick, so the production process is disadvantage in high cost, low production efficiency, huge environmental production investment and large scale of lump-sum investment. Although the cost for producing concrete permeable bricks is low, however, the existing concrete permeable brick has coarse particles on its surface (generally, the particle size of aggregate is 3 mm to 6 mm). Water will permeate it through the large pores with a porosity of above 20% on the surface, however, the pores are easily blocked by dusts, so the brick may not keep high permeability; it has a bad effect for water filtration due to the large pores; moreover, concrete permeable brick has monotonous color, coarse surface, poor appearance, low strength and high frangibility.

The existing polymeric material permeable bricks are hard to be popularized due to high cost of raw materials such as resin. There is thus a great need for developing permeable material products advantaged in energy saving, low cost, good weatherability, long-time high permeability and high strength.

### SUMMARY

An object of the invention is to provide a composite permeable brick with simple structure, low cost, compact surface and high permeability, so as to solve the problems of the concrete permeable bricks in the prior art such as coarse surface particles, permeation depending on pores and poor strength, and the problems of the ceramic permeable brick and the polymeric material permeable brick like high cost.

Another object of the invention is to overcome the shortcomings of permeable materials in the prior art and to provide a mixture for preparing surface layer of the composite permeable brick, which is environment-friendly, saves energy, and has a permeability so high that permeation doesn't rely on large pores.

A further object of the invention is to provide a use of such composite permeable brick for road surfacing, rainwater filtration, water circulation and purification.

To achieve the above objects, the invention provides a composite permeable brick comprising a permeable surface layer and a permeable base layer combined together; wherein the permeable surface layer and the permeable base layer respectively comprise aggregate coated by binder and binder adhering to said aggregate; said binder in the permeable surface layer comprises at least hydrophilic binder; namely, said binder in the permeable surface layer may completely or partially be the hydrophilic binder.

The mass ratio of said binder to said aggregate in the permeable surface layer is from 1:100 to 20:100.

Said binder in the permeable surface layer comprises a resin binder in addition to the hydrophilic binder, said hydrophilic binder is the hydrophilic resin binder, said hydrophilic resin binder is one or more selected from the group consisting of epoxy resin, polyurethane and acrylic resin; the molecular side chains of said epoxy resin, polyurethane and acrylic resin include sufficiently hydrophilic carboxylates, sulphonates, ammonium salts and hydroxyl groups, or the main chains thereof include nonionic hydrophilic segments (such as medium or low molecular weight polyethylene glycol oxide).

Said hydrophilic binder in the permeable surface layer is preferably present in a content of 1% to 60% of the binder in the permeable surface layer.

Said hydrophilic binder in the permeable surface layer is a hydrophilic resin binder, specifically a hydrophilic epoxy resin; said hydrophilic epoxy resin, into which hydrophilic groups are introduced, has excellent hydrophilicity.

Said aggregate in the permeable surface layer has a particle size of 0.05 mm to 2 mm and may be tinted with different colors as needed; to ensure that the permeable surface layer has a very compact and beautiful surface which is hard to be blocked by dusts, the aggregate in the permeable surface layer is quartz sand with a particle size of, more preferably 0.05 mm to 0.85 mm, most preferably 0.07 mm to 0.425 mm; said quartz sand is selected from aeolian sand in the desert.

Said binder in the permeable surface layer may be further added with a small amount of inorganic binder such as silicate, phosphate or cement.

Said permeable surface layer may be added with a coupling agent, preferably a coupling agent containing silicon, titanium or phosphorus element to enhance the bond strength among aggregates. Said permeable surface layer may be added with a light stability agent and/or an antioxidant to enhance the weatherability of the surface layer.

Said permeable brick may be added with a hydrophilic inorganic material, which is one or more selected from diatomite, bentonite and perlite.

Said resin binder is one selected from the group consisting of epoxy resin, polyurethane resin and acrylic resin or any combination thereof; said resin is preferably selected from epoxy resins, polyurethane resins, acrylic resins with good weatherability.

Said resin binder is epoxy resin, and said curing agent for the epoxy resin is aliphatic polyamine or alicyclic polyamine curing agent, which is used in an amount of from 5% to 60% by mass of the epoxy resin.

Said epoxy resin is one or more selected from the group consisting of alicyclic epoxy resin, hydrogenated bisphenol A epoxy resin, organic silicon-modified bisphenol A epoxy resin, saturated glycidic ester epoxy resin, heterocyclic and mixed epoxy resins or any combination thereof.

Said resin binder is a polyurethane resin; said polyurethane resin consists of aliphatic or alicyclic polyester polyols and aliphatic or alicyclic polyisocyanates, and said polyurethane resin may further be added with a urethane grade solvent, a chain extendor and a cross linking agent.

Said binder in the permeable base layer comprises cement which is cheaper to reduce the cost of the brick; said aggregate in the permeable base layer preferably has a particle size of 2 mm to 10 mm to enhance the permeability of the permeable base layer.

The composite permeable brick of the invention may be prepared by one-shot composite molding of the permeable surface layer and the permeable base layer, or by first preparing the permeable surface layer and the permeable base layer separately and then integrating them through, for example, adhesion, or by first preparing either one of the permeable surface layer or the permeable base layer and then molding the other layer thereon.

Moreover, the invention provides the use of said composite permeable brick for road surfacing, rainwater filtration, water circulation or water purification.

Furthermore, to achieve the above purposes, the invention provides a mixture for preparing the surface layer of the composite permeable brick, wherein the mixture comprises aggregate coated by binder and binder adhering to said aggregate. Said binder at least comprises hydrophilic binder.

The ratio of said binder to said aggregate is from 1:100 to 20:100 by mass.

Said hydrophilic binder is 1% to 60% based on the total weight of the binder. Said hydrophilic binder is a hydrophilic resin binder. Said hydrophilic resin binder is one or more selected from epoxide resin, polyurethane and acrylic resin. The molecular side chains of said epoxide resin, polyurethane and acrylic resin include carboxylate groups, sulphonate groups, ammonium salts and hydroxyl groups, or the main chains thereof include nonionic hydrophilic segments.

Said binder comprises a resin binder in addition to the hydrophilic resin binder. Said resin binder is a weather-resistant resin. Said resin binder is one selected from the groups consisting of epoxide resin, polyurethane and acrylic resin or any combination thereof.

Said epoxy resin may further be added with aliphatic polyamine or alicyclic polyamine curing agent, which is used in an amount of from 5% to 60% by mass of the epoxy resin. Said epoxy resin is one selected from the group consisting of alicyclic epoxy resin, hydrobisphenol A epoxy resin, organic silicon-modified bisphenol A epoxy resin, saturated glycidic ester epoxy resin, heterocyclic and mixed epoxy resins or any combination thereof.

Said polyurethane resin consists of aliphatic or alicyclic polyester polyols and aliphatic or alicyclic polyisocyanates. Said polyurethane resin may further be added with a polyurethane-grade solvent, a chain extendor and a cross linking agent. Said polyurethane resin may further be added with a polyurethane curing reaction catalyst. Said polyurethane curing reaction catalyst may be lead naphthenate and/or dibutyltin dilaurate.

Said binder is added with a weather-resistant additive. Said weather-resistant additive comprises one or two of a light stabilizer and an antioxidant.

Said binder may be added with a small amount of an inorganic binder. Said inorganic binder may be silicate, phosphate or cement.

Said mixture may further be added with a coupling agent containing silicon, titanium or phosphorus element.

Said mixture may be added with a hydrophilic inorganic material, which is one or more of diatomite, bentonite and perlite.

Said aggregate is quartz sand, which is selected from aeolian sand in the desert. Said aggregate has a particle size of, more prederbly, 0.05 mm to 0.85 mm, and most preferably of 0.07 mm to 0.425 mm.

Furthermore, the mixture of the invention may also be used for preparing a permeable article applied in road surfacing, rainwater filtration, water circulation and water purification, in addition to the use for preparing the composite permeable brick of the invention.

Said permeable article may be a permeable brick, a permeable board, a permeable tree grate, a permeable street curb, a permeable well cover or a permeable groove.

Moreover, the mixture of the invention may also be directly paved on a pavement to form a permeable pavement.

Thanks to the above solutions, the invention has the following advantages:

(1) Good permeability: the mixture and the composite permeable brick made therefrom of the invention ensure that the surface of the brick is compact and permeable to improve the water permeability effectively so that permeation doesn't rely on large pores and less blockages will happen by using a highly permeable hydrophilic resin and adding a hydrophilic inorganic materials to the aggregate; in addition, fine aggregate having a particle size of 0.05 mm to 0.85 is used, so that the water permeates the brick through capillaries which are not easily blocked by dusts.

(2) Good weatherability: the mixture and the composite permeable brick made therefrom of the invention enhances the capability of oxidation resistance and UV resistance and thus remarkably enhances the weatherability because of the use of binders with good weatherability and the addition of antioxidants and light stabilizers.

(3) Low cost: the aggregate in the invention is quartz sand, particularly aeolian sand in the desert, and the permeable base layer of the composite permeable brick may use a low-cost binder such as cement, so the cost of producing the mixture and the composite permeable brick can be effectively reduced.

(4) Energy-saving: In the composite permeable brick of the invention, the material of the surface layer mainly comprises resin and quartz sand, and the material of the base layer mainly comprises cement, carpolite and quartz sand. The base layer is molded without being sintered. The desert sand used as the main raw material of the aggregate can be recycled, which opens up a new way of controlling desert scientifically, i.e “eats off” the desert gradually and transforms the trash into treasure.

(5) Wide range of applications: permeable materials made from the mixture of the invention may be widely used in gardens, streets, housing construction; they are beautiful and durable, optimize urban environment, and have heat insulation and energy saving capability; they also may be used in a rainwater collection system to collect, filtrate and purify rainwater, to promote the complete use of rainwater resources, and to improve air quality by dust suction and sand fixation; as regards the permeable materials used for surfacing roads, rainwater from either natural or artificial precipitation would rapidly sink into the ground, so that the precipitation resources is fully used, the city water circulation is improved, and groundwater resources are replenished; and they may be used for purifying the river and lake water.

(6) The mixture of permeable materials of the invention is environmental-friendly, energy-saving, non-toxic, tasteless and free from contamination.

### DETAILED DESCRIPTION OF THE INVENTION

Choice of Raw Materials:

(1) Aggregate

Said aggregate may be one selected from the group consisting of natural quartz sand, artificial quartz sand, fly ash and smelting slag or any combination thereof, preferably quartz sand, particularly quartz sand in the desert. With respect to aggregates having different particle sizes, the narrower the distribution coefficient of particle size, the smaller the bulk density, and the better the permeability of the aggregate. The permeability of the monodisperse aggregate is better than that of the polydisperse aggregate. Therefore, the aggregate selected in the invention has a particle size from 0.05 mm to 2 mm, preferably 0.07 mm to 0.85 mm, and most preferably 0.07 mm to 0.425 mm. Said aggregate may be tinted with various colors.

In order to improve the permeability of the permeable material, the aggregate of the invention may be added with a hydrophilic inorganic material, which is present in an amount of 1% to 20% by mass of the aggregate. Said hydrophilic inorganic material may be one or more of diatomite, bentonite and perlite.

(2) Binder

Countless interconnected hydrophilic capillaries are formed among the aggregate particles of the invention by binding the aggregate particles together with a binder prior to curing and molding. When rainwater drops on the surface of hydrophilic permeable material, raindrops will rapidly wet up the hydrophilic capillaries. The fluid surface in the hydrophilic capillaries which is concave will generate an additional downward pressure. Then rainwater will sink rapidly into the ground through the interconnected capillaries under the joint action of said additional downward pressure and the gravity of the liquid.

For the aggregate particles of the same size, as the amount of the binder increase, the bonding force between the aggregate particles will increase so as to increase the compressive strength of the permeable article. However, a binder in an excessive amount would fill the gap between the aggregate particles to reduce the permeability of the permeable article. Thus, there exists an optimum amount of the binder for the permeable article with the aggregate particles of the same size. The ratio of the binder to the aggregate is preferably from 1:100 to 20:100 by mass, most preferably from 2:100 to 10:100 by mass.

A hydrophilic resin binder is selected in the invention, which have molecular side chains including hydrophilic carboxylate groups, sulfonate groups, ammonium salts, hydroxyl groups, or main chains including non-ionic hydrophilic segments. In addition to the hydrophilic binder, the resin binder is comprised in the binder of the invention. Said resin binder is one selected from the group consisting of epoxide resin, polyurethane resin and acrylics resin or any combination thereof.

Additionally, because epoxy resin itself has a thermoplastic linear structure, a curing agent needs to be added in and to react with its epoxy group under certain conditions to generate a product having a space network structure, so that the epoxy material can reveal a variety of excellent performances and have a true use value. The amount of the curing agent, which may affect the use cost and final performance of the desired product, should be as accurate as possible. Too little curing agent may cause incomplete curing and poor performance of the curing agent for the binder, while too much curing agent results in an increased friability and a decreased strength of the adhesive layer, and the residual curing agent would damage the performance of the binder. The optimum use amount of the curing agent leads to the best performance, and this decided by the structure of the curing agent and the reaction course of the network structure formation. Generally the theoretical value of the optimum amount may be calculated according to the strict quantitative relationship of amino groups and epoxy groups, and then determined via experiments. The amount ratio may be selected according to the amine value, and generally, the amount of a curing agent with high amine value is small while the amount of a curing agent with low amine value is large.

Therefore, the epoxy resin of the invention may be further added with aliphatic polyamine or alicyclic polyamine curing agent, which is present in an amount of 5% to 60% by mass of the epoxy resin. The epoxy resin is one selected from alicyclic epoxy resin, hydrobisphenol A epoxy resin, organic silicon-modified bisphenol A epoxy resin, saturated glycidic ester epoxy resin, heterocyclic and mixed epoxy resins or any combination thereof.

The polyurethane resin used in the invention consists of an aliphatic or alicyclic polyester polyol and an aliphatic or alicyclic polyisocyanate with good weatherability. Said polyisocyanate is one or more selected from the group consisting of 1,6-hexamethylene diisocyanate HDI, isophorone diisocyanate IPDI, xylyl diisocyanate XDI, methylcyclohexyl diisocyanate HTDI, dicyclohexylmethylmethane diisocyanate HMDI, tetramethylenexylene diisocyanate TMXDI, HDI biuret, HDI tripolymer, IPDI tripolymer, TDI-HDI mixed tripolymer and prepolymer. Said aliphatic polylol is one or more selected from polyester polylol, polyether polylol based on tetrahydrofuran, and acrylic resin or silicon resin containing hydroxyl group.

The polyurethane resin of the invention may be further added with a polyurethane curing reaction catalyst, which is preferably one of an organic tin catalyst and a lead catalyst. Suitable examples of the organic tin catalyst are dibutyltin dilaurate, stannous octoate or stannous isooctoate, and said lead catalyst is lead naphthenate or lead isooctanoate.

The polyurethane resin of the invention may be further added with a chain extender and a cross linker, which are alcohols and amines.

In addition, the polyurethane resin of the invention may be further added with a urethane-grade solvent, which is preferably one or more selected from ethyl acetate, methyl acetate, dimethyl succinate and diethyl succinate. The polyurethane resin of the invention may be further added with a chain extender and a cross linker, which are preferably selected from alcohols and amines. Said alcohols and amines are one or more selected from 1,4-butanediol, 1,6-hexanediol, trimethylolpropane, 3,3′-dichloro-4,4′-diamino-diphenyl methane MOCA.

In addition, the polyurethane resin of the invention may be further added with a weather-resistant additive, which comprises one or more of a light stabilizer and an antioxidant. The amount of the light stabilizer is from 0.1% to 5% by mass of the resin in the invention. Said light stabilizer is any one or more selected from benzophenones, salicylates, benzotriazoles, hindered amines, light stabilizer HPT and light stabilizer EPU. Specifically, light stabilizers fit for the binder of the invention include benzophenones (UV-207, UV-9, UV-531, UV-A, MA, D49 and light stabilizer-50, etc), salicylates (light stabilizer TBS, light stabilizer BAD, etc), benzotriazoles (UV-P, UV-320, UV-326, UV-327, UV-328 and UV-5411, etc), hindered amines (light stabilizer 744, light stabilizer 144, hindered amine 770, light stabilizer 292, ect), light stabilizer HPT and light stabilizer EPU, etc. The amount of the antioxidant is preferably from 0.1% to 4% by mass of the resin in the invention. Said antioxidant is one or more selected from antioxidant 1222, AT-76, antioxidant 2246-S, AT-59, antioxidant 1035, antioxidant 1098, antioxidant 3215, TPP, TNPP, AT-168, antioxidant 245, GA-80, antioxidant 858 and antioxidant 1010.

Wherein, the light stabilizer of the invention is used as an auxiliary agent for improving the light stability of polymeric materials, which can shield UV radiation or absorb UV radiation and converts it to harmless heat energy, or quench the excited state of moleculars or groups excited by UV radiationto restore it to the ground state, or capture free radicals generated by photo-oxidation to prevent the photo-oxidation reaction from continuing, so as to prevent the polymeric materials from being damaged by UV radaition. The antioxidant is used to enhance inoxidability of the permeable material and avoid oxidation of the permeable brick, which is caused by the self-factors of the brick and environmental factors and thus may lead to the degradation or loss of the permeability of the brick.

Furthermore, in order to improve the flame retardantance, a flame ressistant epoxy resin or a flame retardant may also be added. Suitable examples of the flame resistant epoxy resin are brominated epoxy resin, chlorinated epoxy resin phosphorus-containing epoxy resin and nitrogen-containing epoxy resin.

The mixture of the invention may be further added with a coupling agent, which is present in an amount of 0% to 10% by mass of the resin, preferably 0.5% to 5.0%. Preferably, said coupling agent contains silicon, titanium, phosphorus and the like.

### Examples

In order to further verify the beneficial effects of the invention, the inventor has conducted a number of experiments and some representative examples are enumerated hereafter to further illustrate the present invention.

The following are some specific examples of the composite permeable brick of the invention:

### Example 1

A composite permeable brick comprised a permeable surface layer and a permeable base layer. The raw materials for preparing the permeable surface layer were as follows: 100 g of quartz sand of 0.4 to 0.2 mm which was dyed cyan, 4.6 g of hydrobisphenol A epoxy resin, 0.5 g of hydrophilic epoxy resin, 1.4 g of an aliphatic polyamine curing agent, 0.12 g of epoxy propoxy propyltrimethoxysilicane 560 as a coupling agent, 0.012 g of a light stabilizer UV-320, and 0.006 g of an antioxidant 1010 and 1.0 g of pearlite powder. The raw materials for preparing the permeable base layer were quartz sand having a particle size of 2 mm to 3 mm, and cement as a binder. The thickness ratio of the surface layer to the base layer of the finished permeable brick was 2:3. The comparison on performance indexes between the product and the ordinary permeable brick are shown in Table 1.

### Example 2

A composite permeable brick comprised a permeable surface layer and a permeable base layer. The raw materials for preparing the permeable surface layer were as follows: 10 kg of quartz sand of 0.07 to 0 2 mm which was dyed green, 600 g of hydroxyl-containing acrylic resin and 200 g of 75% of HDI biuret as a binder, 6 g of hydrophilic epoxide resin, 1 g of cement, 5 g of silicate, 3.0 g of a silane coupling agent 550, 0.6 g of a light stabilizer UV-326, 0.9 g of an antioxidant 1010 and 0.9 g of dibutyltin dilaurate as a curing reaction catalyst. The raw materials for preparing the permeable base layer were quartz sand having a particle size of 2 to 4 mm, and cement as a binder. The thickness ratio of the surface layer and the base layer of the finished permeable brick was 1:3. The comparison on performance indexes between the product and the ordinary permeable brick are shown in Table 2.

### Example 3

A composite permeable brick comprised a permeable surface layer and a permeable base layer. The raw materials for preparing the permeable surface layer were as follows: 15 kg of quartz sand of 0.2 to 0.4 mm which was dyed black, 600 g of a 70% 650 polyester solution and 560 g of a 75% HDI biuret as a binder, 10 g of diatomite, 360 g of hydrophilic epoxide resin, 10 g of cement, 5 g of a silane coupling agent 550, 0.6 g of a light stabilizer UV-327, 0.9 g of an antioxidant 1222, 1.8 g of zinc naphthenate, 20 g of trimethylolpropane as the extender and cross linker and 15 g of ethyl methyl ketone as a urethane grade solvent. The raw materials for preparing the permeable base layer were quartz sand having a particle size of 2 to 4 mm, and cement as binder. The thickness ratio of the surface layer and the base layer of the finished permeable brick was 2:7. The comparison on performance indexes between the product and the ordinary permeable brick are shown in Table 3.

### Example 4

Only hydrophilic epoxy resins were used as binders in the permeable surfaces layers of all of examples 1 to 3, while the other materials were unchanged. The test results of the resulting permeable bricks are consistent with those in examples 1 to 3, the permeability (permeation coefficient) of all the bricks were increased significantly on the premise of keeping normal compressive strength, bending strength, wear resistance and water retention.

### Example 5

The hydrophilic epoxy resins in the permeable surface layers of examples 1 to 4 were replaced respectively by hydrophilic polyurethane resins and hydrophilic acrylic resins, the permeability of the resulting composite permeable bricks was increased significantly.

Based on the above examples, we can see that the permeability of the permeable bricks is increased significantly and the cost is decreased effectively by adopting the technical solution of the invention.

TABLE 1

| | | STANDARD INDEX | | Permeable Brick | |
|---|---|---|---|---|---|
| SN | ITEM | (JC/T945-2005) | | of the Invention | |
| 1 | Compressive | Grade | Average value ≧ | 48 | MPa |
| | strength | | 35.0 MPa | | |
| | | Cc35 | One block value ≧ | 45 | MPa |
| | | | 30.0 MPa | | |

| 2 | Bending failure | Side length/thickness ≧ | 10627N | |
|---|---|---|---|---|
| | load | 5 ≧ 6000N | | |
| 3 | Wear resistance | Wear length≦35 mm | 28.5 | mm |
| 4 | Water retention | ≧0.6 g/cm² | 0.68 | g/cm² |
| 5 | Permeability | ≧1.0 × 10⁻² cm/s | 6.8 × 10⁻² | cm/s |
| | coefficient (water | | | |
| | temperature | | | |
| | 15° C.) | | | |

TABLE 2

| | | STANDARD INDEX | | Permeable Brick | |
|---|---|---|---|---|---|
| SN | ITEM | (JC/T945-2005) | | of the Invention | |
| 1 | Compressive | Grade | Average value ≧ | 39.5 | MPa |
| | strength | | 35.0 MPa | | |
| | | Cc35 | One block value ≧ | 37.2 | MPa |
| | | | 30.0 MPa | | |

| 2 | Bending failure | Side length/thickness ≧ 5 ≧ | 11249N | |
|---|---|---|---|---|
| | load | 6000N | | |
| 3 | Wear resistance | Wear length ≦ 35 mm | 26.5 | mm |
| 4 | Water retention | ≧0.6 g/cm² | 0.70 | g/cm² |
| 5 | Permeability | ≧1.0 × 10⁻² cm/s | 6.8 × 10⁻² | cm/s |
| | coefficient (water | | | |
| | temperature | | | |
| | 15° C.) | | | |

TABLE 3

| | | STANDARD INDEX | | Permeable Brick | |
|---|---|---|---|---|---|
| SN | ITEM | (JC/T945-2005) | | of the Invention | |
| 1 | Compressive | Grade | Average | 40.5 | MPa |
| | strength | | value ≧ 35.0 MPa | | |
| | | Cc35 | One block | 38.5 | MPa |
| | | | value ≧ 30.0 MPa | | |

| 2 | Bending failure | side length/thickness ≧ | 12370N | |
|---|---|---|---|---|
| | load | 5 ≧ 6000N | | |
| 3 | Wear resistance | Wear length ≦ 35 mm | 25.5 | mm |
| 4 | Water retention | ≧0.6 g/cm² | 0.69 | g/cm² |
| 5 | Permeability | ≧1.0 × 10⁻² cm/s | 6.7 × 10⁻² | cm/s |
| | coefficient (water | | | |
| | temperature | | | |
| | 15° C.) | | | |

From the aspects of compressive strength, wear resistance, water retention and permeability coefficient, etc., the performance parameters of the composite permeable brick of the invention are illustrated in the above tables. It can be seen from said tables that the compressive strength of the composite permeable brick of the invention exceeds the average value of grade Cc35, up to more than 35 MPa, and the permeability coefficient is far beyond standard index of 1.0×10−2 cm/s, up to 6.8×10−2 cm/s. Therefore, the composite permeable brick of the invention has excellent compressive strength and water permeability as well as good wear resistance and water retention.

The above composite permeable brick of the invention, may be made by one-shot composite molding of the permeable surface layer and the permeable base layer, or by first preparing the permeable surface layer and the permeable base layer separately and then integrating them, through, for example, adhesion, or by first preparing the permeable surface layer or the permeable base layer and then molding the other layer thereon.

In addition to the above formulations, there still are many different formulations for the mixture for preparing the surface layer of the composite permeable brick of the invention. The following examples 6 to 15 are different embodiments about the production of the mixture for preparing the surface layer of the composite permeable brick of the invention. The mixture was compressed into bricks, of which the various performance parameters are shown in Table 4 to Table 13.

### Example 6

100 g of quartz sand of 0.4 to 0.2 mm which was dyed cyan, 4.6 g of hydrobisphenol A epoxy resin (wherein 0.92 g of hydrobisphenol A epoxy resin has molecular side chains including hydrophilic carboxylate), 1.4 g of an aliphatic polyamine curing agent, 0.12 g of epoxy propoxy propyltrimethoxysilicane 560 as a coupling agent, 0.012 g of a light stabilizer UV-320, and 0.006 g of an antioxidant 1010 were mixed and then moulded to produce a permeable brick. The compressive strength of the brick is up to 42.3 MPa via tests (See Table 4 for details).

### Example 7

100 g of quartz sand of 0.1 to 0.2 mm which was dyed cyan, 4.6 g of hydrobisphenol A epoxy resin (wherein 0.46 g of hydrobisphenol A epoxy resin has molecular side chain including hydrophilic carboxylate), 1.4 g of an aliphatic polyamine curing agent, 0.12 g of epoxy propoxy propyltrimethoxysilicane 560 as a coupling agent, 0.012 g of a light stabilizer UV-320 and 0.006 g of an antioxidant 1010 were mixed and then moulded to produce a permeable brick. The compressive strength of the brick is up to 39.7 MPa vis tests (See Table 5 for details).

### Example 8

100 g of quartz sand of 0.15 to 0.3 mm which was dyed cyan, 4.6 g of hydrobisphenol A epoxy resin (wherein 0.46 g of hydrobisphenol A epoxy resin has molecular side chains including hydrophilic carboxylate), 1.4 g of an aliphatic polyamine curing agent, 0.12 g of epoxy propoxy propyltrimethoxysilicane 560 as a coupling agent, 0.012 g of a light stabilizer UV-320, and 0.006 g of an antioxidant 1010 were mixed and then moulded to produce a permeable brick. The compressive strength of the brick is up to 45.4 MPa via tests (See Table 6 for details).

### Example 9

100 g of quartz sand of 0.15 to 0.3 mm which was dyed cyan, 4.6 g of hydrobisphenol A epoxy resin (wherein 0.46 g of hydrobisphenol A epoxy resin has molecular side chains including hydrophilic carboxylate), 1.4 g of an aliphatic polyamine curing agent, 0.12 g of epoxy propoxy propyltrimethoxysilicane 560 as coupling agent, 0.012 g of a light stabilizer UV-320, and 0.006 g of an antioxidant 1010 were mixed and then moulded to produce a permeable brick. The compressive strength of the brick is up to 46.4 MPa via tests (See Table 7 for details).

### Example 10

10 Kg of quartz sand of 0.07 to 0.4 mm, 1 Kg of pearlite powder, 1.2 Kg of hydrophilic polyurethane as a binder, 6 g of a light stabilizer HPT, 6 g of an antioxidant 1035 and 12 g of a silicone-containing coupling agent were thoroughly mixed, and then made into a rainwater filter layer with a thickness of 20 cm. The filtrated rainwater is free of solid impurities, clear and may be used for car wash (See Table 8 for details).

It is understood from the above examples that the aggregate of the permeable product of the invention has a small particle size, water permeates the synthesized product through tiny capillarity to keep a good permeability and make the surface of the brick smooth, beautiful, skidproof and wearable, at the same time, pores on the surface of the brick ares not easy to be blocked so that it has a water permeability of long life. The sand used in the invention remarkably increases the permeability and weatherability of the permeable product.

### Example 11

### Permeable Brick with the Mass Ratio of Binder to Aggregate of 8:100

100 Kg of quartz sand of 0.2 to 0.4 mm which was dyed cyan, 6 Kg of hydrobisphenol A epoxy resin (wherein 0.9 g of hydrobisphenol A epoxy resin has the molecular side chains including hydrophilic carboxylate) and 2 Kg of a polyamine curing agent were mixed and then moulded to produce a permeable brick. The compressive strength of the brick is up to 53 MPa via tests (See Table 9 for details).

### Example 12

### Permeable Brick with the Mass Ratio of Binder to Aggregate of 5:100

100 Kg of quartz sand of 0.2 to 0.4 mm which was dyed cyan, 3.76 Kg of hydrobisphenol A epoy resin (wherein 0.56 Kg of hydrobisphenol A epoxy resin has the molecular side chains including hydrophilic carboxylate) and 1.24 g of a polyamine curing agent were mixed and then moulded to produce a permeable brick. The compressive strength of the brick is up to 35.6 MPa via tests (See Table 10 for details).

### Example 13

10 Kg of quartz sand of 0.07 to 0.2 mm which was dyed green, 600 g of hydroxyl-containing acrylic resin (wherein 120 g of acrylic resin has the molecular side chains including hydrophilic sulphonate) and 200 g of a 75% HDI biurea as a binder, 3.0 g of a silane coupling agent 550, 0.6 g of a light stabilizer UV-326, 0.9 g of an antioxidant 1010 and 0.9 g of dibutyltin dilaurate as a curing reaction catalyst were mixed and then moulded to produce a permeable brick. The compressive strength of the brick is up to 38 MPa via tests (See Table 11 for details).

### Example 14

10 Kg of quartz sand of 0.07 to 0 2 mm which was dyed black, 600 g of a 75% 650 polyurethane solution (wherein 200 g of the polyurethane solution has the molecular side chains including hydrophilic ammonium salt)and 560 g of a 75% HDI biuret solution as a binder, 5.0 g of a silane coupling agent 550, 0.6 g of a light stabilizer UV-327, 0.9 g of an antioxidant 1222, 1.8 g of zinc naphthenate; 20 g of trimethylolpropane as the extender and cross linker and 15 g of ethyl methyl ketone as a urethane grade solvent were mixed and produce a block sample. The compressive strength of the block sample is up to 40.3 MPa via tests (See Table 12 for details).

### Example 15

10 Kg of quartz sand of 0.07 to 0 2 mm which was dyed red, 100 g of diatomite, 1 Kg of hydrobisphenol A epoxy resin (wherein 1 Kg of hydrobisphenol A epoxy resin has the molecular side chains including hydrophilic sulphonate group) as a binder; 400 g of an aliphatic polyamine curing agent, 1.98 g of a light stabilizer EPU, 1.98 g of an antioxidant 1035 were thoroughly mixed. The resulting mixture was then laid on a carpolite roadbed compacted and smoothed to form a permeable layer 15 cm thick, wherein said carpolite roadbed was formed by laying small stones on the pre-selected one square meter road followed tamping, with a thickness of 20 cm. The permeable layer was tested 5 days later.

TABLE 4

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 42.3 | MPa |
| | strength | | value ≧ 35.0 MPa | | |
| | | Cc35 | One block | 39.5 | MPa |
| | | | value ≧ 30.0 MPa | | |

| 2 | Bending failure | side length/thickness ≧ | 10627N | |
|---|---|---|---|---|
| | load | 5 ≧ 6000N | | |
| 3 | Wear resistance | Wear length ≦ 35 mm | 25.5 | mm |
| 4 | Water retention | ≧0.6 g/cm² | 1.03 | g/cm² |
| 5 | Permeability | ≧1.0 × 10⁻² cm/s | 7.3 × 10⁻² | cm/s |
| | coefficient (water | | | |
| | temperature 15) | | | |

TABLE 5

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 39.7 | MPa |
| | strength | | value ≧ 35.0 MPa | | |
| | | Cc35 | One block | 36.5 | MPa |
| | | | value ≧ 30.0 MPa | | |

| 2 | Bending failure | side length/thickness ≧ | 11250N | |
|---|---|---|---|---|
| | load | 5 ≧ 6000N | | |
| 3 | Wear resistance | Wear length ≦ 35 mm | 28.5 | mm |
| 4 | Water retention | ≧0.6 g/cm² | 1.10 | g/cm² |
| 5 | Permeability | ≧1.0 × 10⁻² cm/s | 2.1 × 10⁻² | cm/s |
| | coefficient (water | | | |
| | temperature 15) | | | |

TABLE 6

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 45.4 | MPa |
| | strength | | value ≧ 35.0 MPa | | |
| | | Cc35 | One block | 41.5 | MPa |
| | | | value ≧ 30.0 MPa | | |

| 2 | Bending failure | side length/thickness ≧ | 12370N | |
|---|---|---|---|---|
| | load | 5 ≧ 6000N | | |
| 3 | Wear resistance | Wear length ≦ 35 mm | 26.5 | mm |
| 4 | Water retention | ≧0.6 g/cm² | 0.94 | g/cm² |
| 5 | Permeability | ≧1.0 × 10⁻² cm/s | 3.3 × 10⁻² | cm/s |
| | coefficient (water | | | |
| | temperature 15) | | | |

TABLE 7

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 46.4 | MPa |
| | strength | | value ≧ 35.0 MPa | | |
| | | Cc35 | One block | 24.5 | MPa |
| | | | value ≧ 30.0 MPa | | |

| 2 | Bending failure | side length/thickness ≧ | 11250N | |
|---|---|---|---|---|
| | load | 5 ≧ 6000N | | |
| 3 | Wear resistance | Wear length ≦ 35 mm | 28.5 | mm |
| 4 | Water retention | ≧0.6 g/cm² | 1.05 | g/cm² |
| 5 | Permeability | ≧1.0 × 10⁻² cm/s | 13.6 × 10⁻² | cm/s |
| | coefficient | | | |
| | (water | | | |
| | temperature 15) | | | |

TABLE 8

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 41.5 | MPa |
| | strength | Cc35 | value ≧ 35.0 MPa | | |

| | | | | |
|---|---|---|---|---|
| 2 | Wear resistance | Wear length ≦ 35 mm | 25.5 | mm |
| 3 | Water retention | ≧0.6 g/cm² | 0.80 | g/cm² |
| 4 | Permeability | ≧1.0 × 10⁻² cm/s | 7.2 × 10⁻² | cm/s |
| | coefficient (water | | | |
| | temperature 15) | | | |

TABLE 9

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 53.0 | MPa |
| | strength | Cc50 | value ≧ 50.0 MPa | | |

| | | | | |
|---|---|---|---|---|
| 2 | Wear resistance | Wear length ≦ 35 mm | 25.5 | mm |
| 3 | Water retention | ≧0.6 g/cm² | 0.65 | g/cm² |
| 4 | Permeability | ≧1.0 × 10⁻² cm/s | 2.4 × 10⁻² | cm/s |
| | coefficient (water | | | |
| | temperature 15) | | | |

TABLE 10

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 35.6 | MPa |
| | strength | Cc35 | value ≧ 35.0 MPa | | |

| | | | | |
|---|---|---|---|---|
| 2 | Wear resistance | Wear length ≦ 35 mm | 25.5 | mm |
| 3 | Water retention | ≧0.6 g/cm² | 0.90 | g/cm² |
| 4 | Permeability | ≧1.0 × 10⁻² cm/s | 4.0 × 10⁻² | cm/s |
| | coefficient (water | | | |
| | temperature 15) | | | |

TABLE 11

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 38.5 | MPa |
| | strength | | value ≧ 35.0 MPa | | |
| | | Cc35 | One block | 36.5 | MPa |
| | | | value ≧ 30.0 MPa | | |

| 2 | Bending failure | side length/thickness ≧ | 11250N | |
|---|---|---|---|---|
| | load | 5 ≧ 6000N | | |
| 3 | Wear resistance | Wear length ≦ 35 mm | 26.5 | mm |
| 4 | Water retention | ≧0.6 g/cm² | 0.70 | g/cm² |
| 5 | Permeability | ≧1.0 × 10⁻² cm/s | 6.6 × 10⁻² | cm/s |
| | coefficient (water | | | |
| | temperature 15) | | | |

TABLE 12

| | | | | STS-based | |
|---|---|---|---|---|---|
| | | STANDARD | | Permeable Brick | |
| SN | ITEM | INDEX(JC/T945-2005) | | of the Invention | |
| 1 | Compressive | Grade | Average | 40.5 | MPa |
| | strength | | value ≧ 35.0 MPa | | |
| | | Cc35 | One block | 38.5 | MPa |
| | | | value ≧ 30.0 MPa | | |

| 2 | Bending failure | side length/thickness ≧ | 12370N | |
|---|---|---|---|---|
| | load | 5 ≧ 6000N | | |
| 3 | Wear resistance | Wear length ≦ 35 mm | 25.5 | mm |
| 4 | Water retention | ≧0.6 g/cm² | 0.69 | g/cm² |
| 5 | Permeability | ≧1.0 × 10⁻² cm/s | 6.7 × 10⁻² | cm/s |
| | coefficient (water | | | |
| | temperature 15) | | | |

TABLE 13

| | | | | STS-based | |
|---|---|---|---|---|---|
| | | STANDARD INDEX | | Permeable Brick | |
| SN | ITEM | (JC/T945-2005) | | of the Invention | |
| 1 | Compressive | Grade | Average | 58.5 | MPa |
| | strength | Cc35 | value ≧ 35.0 MPa | | |

| | | | | |
|---|---|---|---|---|
| 2 | Wear resistance | Wear length ≦ 35 mm | 25.5 | mm |
| 3 | Water retention | ≧0.6 g/cm² | 1.80 | g/cm² |
| 4 | Permeability | ≧1.0 × 10⁻² cm/s | 7.1 × 10⁻² | cm/s |
| | coefficient (water | | | |
| | temperature 15) | | | |

Also, the performance parameters of the composite permeable brick of the invention are illustrated in the above tables from the aspects of compressive strength, wear resistance, water retention and permeability coefficient, etc. It can be seen from the above tables that the compressive strength of the composite permeable brick made by pressing the mixture of the invention is above the average value of the grade, up to more than 58 MPa; wear length of the wear resistance index is about 25 mm, far less than the average value of 35 mm; and the permeability coefficient is far beyond the standard index of 1.0×10−2 cm/s, up to 7.1×10−2 cm/s. Therefore, the composite permeable brick of the invention has an excellent water permeability.

Additionally, the base layer of the composite permeable brick of the invention comprises an aggregate and a binder that adheres to the aggregate, wherein the binder used in the base layer may be identical with the hydrophilic binder in the surface layer or with the various resin binders in the abovementioned layers.

The following are the examples of the composite permeable brick of the invention, wherein the same binders are used in the base layer and the surface layer.

### Example 16

A composite permeable brick comprised a permeable surface layer and a permeable base layer. The raw materials for preparing the permeable surface layer were as follows: 100 g of quartz sand of 0.4 to 0.2 mm which was dyed cyan, 4.6 g of hydrobisphenol A epoxy resin, 0.5 g of hydrophilic epoxide resin, 1.4 g of an aliphatic polyamine curing agent, 0.12 g of epoxy propoxy propyltrimethoxysilicane 560 as a coupling agent, 0.012 g of a light stabilizer UV-320, 0.006 g of an antioxidant 1010 and 1.0 g of perlite powder. The raw materials for preparing the permeable base layer were as follows: 100 g of quartz sand having a particle size of 2 to 3 mm, 4 g of hydrobisphenol A epoxy resin, 0.3 g of hydrophilic epoxide resin, 1.2 g of an aliphatic polyamine curing agent, 0.10 g of epoxy propoxy propyltrimethoxysilicane 560 as a coupling agent, 0.01 g of a light stabilizer UV-320, 0.004 g of an antioxidant 1010 and 1.0 g of pearlite powder. The thickness ratio of the surface layer to the base layer of the finished permeable brick was 2:3. The comparison on performance indexes between the product and the ordinary permeable brick are shown in Table 14.

### Example 17

A composite permeable brick comprised a permeable surface layer and a permeable base layer. The raw materials for preparing the permeable surface layer were as follows: 15 Kg of quartz sand of 0.2 to 0 4 mm which was dyed black, 600 g of a 70% 650 polyester solution and 560 g of a 75% of HDI biuret solution as a binder, 10 g of diatomite, 360 g of hydrophilic epoxide resin, 5 g of a silane coupling agent 550, 0.6 g of a light stabilizer UV-327, 0.9 g of antioxidant 1222, 1.8 g of zinc naphthenate, 20 g of trimethylolpropane as the extender and cross linker, 15 g of ethyl methyl ketone as urethane grade solvent. The raw materials for preparing the permeable base layer were as follows: 12 Kg of quartz sand of 2 to 4 mm, 500 g of hydroxyl-containing acrylic resin and 250 g of a 75% of HDI biuret as binder, 5 g of hydrophilic epoxide resin, 2.5 g of silane coupling agent 550, 0.5 g of a light stabilizer UV-326, 0.8 g of antioxidant 1010 and 0.8 g of dibutyltin dilaurate as a curing agent catalyst. The thickness ratio of the surface layer and the base layer of the finished permeable brick was 2:7. The comparison on performance indexes between the product and the ordinary permeable brick are shown in Table 15.

TABLE 14

| | | STANDARD INDEX | | Permeable Brick | |
|---|---|---|---|---|---|
| SN | ITEM | (JC/T945-2005) | | of the Invention | |
| 1 | Compressive | Grade | Average | 48.5 | MPa |
| | strength | | value ≧ 35.0 MPa | | |
| | | Cc35 | One block | 45.3 | MPa |
| | | | value ≧ 30.0 MPa | | |

| 2 | Bending failure | Side length/thickness ≧ | 10710N | |
|---|---|---|---|---|
| | load | 5 ≧ 6000N | | |
| 3 | Wear resistance | Wear length ≦ 35 mm | 29.5 | mm |
| 4 | Water retention | ≧0.6 g/cm² | 0.71 | g/cm² |
| 5 | Permeability | ≧1.0 × 10⁻² cm/s | 7.1 × 10⁻² | cm/s |
| | coefficient (water | | | |
| | temperature 15) | | | |

TABLE 15

| | | STANDARD INDEX | | Permeable Brick | |
|---|---|---|---|---|---|
| SN | ITEM | (JC/T945-2005) | | of the Invention | |
| 1 | Compressive | Grade | Average | 39.8 | MPa |
| | strength | | value ≧ 35.0 MPa | | |
| | | Cc35 | One block | 37.6 | MPa |
| | | | value ≧ 30.0 MPa | | |

| 2 | Bending failure | Side length/thickness ≧ | 11265N | |
|---|---|---|---|---|
| | load | 5 ≧ 6000N | | |
| 3 | Wear resistance | Wear length ≦ 35 mm | 27.5 | mm |
| 4 | Water retention | ≧0.6 g/cm² | 0.73 | g/cm² |
| 5 | Permeability | ≧1.0 × 10⁻² cm/s | 6.7 × 10⁻² | cm/s |
| | coefficient (water | | | |
| | temperature 15) | | | |

The composite permeable brick according to the invention may be made into various shapes as required, such as cube, cuboid, cylinder, lozenge, or even all kinds of irregular shapes. Additionally, the composite permeable brick according to the invention may be of different specifications and sizes. Furthermore, it may be a solid or a hollow composite permeable brick as needed.

In addition, besides the composite permeable brick of the invention, the mixture of the invention may also be used for preparing various permeable articles for road surfacing, rainwater filtration, water circulation and water purification such as a permeable brick, a permeable board, a permeable tree grate, a permeable street curb, a permeable well cover or a permeable groove, or directly be used for surfacing road to form a permeable pavement.

Moreover, the composite permeable brick and the mixture of the invention may be widely used, for example, in road surfacing, water circulation system, water filtration system and water purification system. For instance, if the composite permeable bricks and mixtures of the invention are used in parks, streets or urban pavements, when it rains, the rainwater shall sink directly into the ground through the permeable bricks to make people free from the inconvenience of stagnant water to replenish groundwater resources so as to make a full use of the water resources; They may also be made into various water-circulation, water-filtration and water-purification units for all kinds of water circulation, filtration and purification systems to promote the water circulation, water filtration, and water purification in cities, e.g., the composite permeable bricks of the invention, which have been made into bricks having various shapes, different sizes and a solid structure or hollow structure, as well as the mixture of the invention can be made into a water filtration unit, then further made into rockeries of different shapes or various simulated buildings. They may also be used in rivers or lakes to filter, purify and recycle river water or lake water due to their high permeability, thus preparing rivers and lakes more beautiful, controlling water pollution, further promoting the ecological balance of the organisms in rivers or lakes.

Certainly, there are many other embodiments for the invention. It will be appreciated by those skilled in the art that all kinds of changes and modifications may be made thereto without going against the spirit and substance of the invention but all the changes and modifications shall fall within the scopes of protection of the claims for the invention.

### INDUSTRIAL APPLICABILITY

The permeable material of the invention can be widely applied to parks, streets and buildings, and to rainwater collecting system for collecting, filtrating and purifying rainwater, promoting the use of rainwater resources, and improving air quality by dust suction and sand fixation; wherein the permeable material used in road surfacing allows natural rainwater and artificial rainwater to sink into the ground rapidly, thus fully preparing use of rainwater resources, improving the urban water circulation and replenishing groundwater resources, and can be used for purifying river water and lake water.

1. A composite permeable brick for rainwater collection, water circulation or water filtration and purification comprising a permeable surface layer and a permeable base layer, wherein said permeable surface layer and said permeable base layer, which respectively comprise an aggregate and a binder adhering to the aggregate, are closely combined; said aggregate is quarts sand; said binder in the permeable surface layer at least comprises a hydrophilic binder; and said aggregate in the permeable surface layer has a particle size of more than 0.05 mm and less than 0.5 mm.

2. The composite permeable brick of claim 1, wherein the mass ratio of the binder to the aggregate in said permeable surface layer is from 1:100 to 20:100.

3. The composite permeable brick of claim 1, wherein said binder in the permeable surface layer comprises a resin binder in addition to the hydrophilic binder.

4. The composite permeable brick of claim 1, wherein said hydrophilic binder in the permeable surface layer is present in a content of 1% to 60% of the binder in the permeable surface layer.

5. The composite permeable brick of claim 1, wherein said hydrophilic binder in the permeable surface layer is a hydrophilic resin binder.

6. The composite permeable brick of claim 5, wherein said hydrophilic resin binder is one or more selected from the group consisting of epoxy resin, polyurethane and acrylic resin, said epoxy resin, polyurethane and acrylic resin having the molecular side chains including hydrophilic carboxylates, sulphonates, ammonium salts and hydroxyl groups, or main chains including nonionic hydrophilic segments.

7. The composite permeable brick of claim 1, wherein said binder in the permeable base layer comprises cement, and said aggregate in the permeable base layer has a particle size of 2 mm to 10 mm.

8. The composite permeable brick of claim 1, wherein said binder in the permeable base layer is a resin binder comprising a hydrophilic binder, and said aggregate in the permeable base layer has a particle size of 2 mm to 10 mm.

9. The composite permeable brick of claim 3 wherein said resin binder is one selected from the group consisting of epoxy resin, polyurethane resin and acrylic resin or any combination thereof.

10. The composite permeable brick of claim 9, wherein said resin binder is an epoxy resin cured by an aliphatic polyamine or alicyclic polyamine curing agent, which is used in an amount of from 5% to 60% by mass of the epoxy resin.

11. The composite permeable brick of claim 10, wherein said epoxy resin is one selected from the group consisting of alicyclic epoxy resin, hydrobisphenol A epoxy resin, organic silicon-modified bisphenol A epoxy resin, saturated glycidic ester type epoxy resin and heterocyclic and mixed epoxy resin or any combination thereof.

12. The composite permeable brick of claim 9, wherein said resin-binder is polyurethane resin; said polyurethane resin comprises aliphatic polyol and polyisocyanate, and may further be added with a urethane-grade solvent, a chain extender and a cross linker.

13. The composite permeable brick of claim 12, wherein said polyurethane resin is further added with a polyurethane curing reaction catalyst.

14. The composite permeable brick of claim 1, wherein said binder in the permeable surface layer is added with a small amount of an inorganic binder.

15. The composite permeable brick of claim 14, wherein said inorganic binder is silicate, phosphate or cement.

16. The composite permeable brick of claim 1, wherein said permeable surface layer further comprises a coupling agent containing silicon, titanium or phosphorus element.

17. The composite permeable brick of claim 1, wherein said permeable surface layer is further added with a light stability agent and/or an antioxidant.

18. The composite permeable brick of claim 1, wherein said permeable brick is added with a hydrophilic inorganic material, which is one or more selected from the group consisting of diatomite, bentonite and perlite.

19. The composite permeable brick of claim 1, wherein said quartz sand is selected from aeolian sand in desert.

20-54. (canceled)

55. A mixture for preparing the surface layer of the composite permeable brick for rainwater collection, water circulation or water filtration and purification comprising an aggregate and a binder adhering to the aggregate; said aggregate is quartz sand; said binder at least comprises a hydrophilic binder; said aggregate has a particle size of more than 0.05 mm and less than 0.5 mm.

56. The mixture of claim 55, wherein the mass ratio of the binder to the aggregate is from 1:100 to 20:100.

57. The mixture of claim 55, wherein said binder comprises a resin binder in addition to the hydrophilic binder.

58. The mixture of claim 55, wherein said hydrophilic binder is present in a content of 1% to 60% based on the total amount of the binder.

59. The mixture of claim 55 , wherein said hydrophilic binder is a hydrophilic resin binder.

60. The mixture of claim 59, wherein said hydrophilic binder is one or more selected from the group consisting of epoxide resin, polyurethane resin and acrylic resin, said epoxide resin, polyurethane and acrylic resin having molecular side chains containing carboxylate groups, sulphonate groups, ammonium salts and hydroxyl groups, or main chains containing nonionic hydrophilic segments.

61. The mixture of claim 57, wherein said resin binder is one selected from the group consisting of epoxy resin, polyurethane resin and acrylic resin or any combination thereof.

62. The mixture of claim 61, wherein said epoxy resin is further added with aliphatic polyamine or alicyclic polyamine curing agent, which is used in an amount of from 5% to 60% by mass of the epoxy resin.

63. The mixture of claim 62, wherein said epoxy resin is one selected from the group consisting of alicyclic epoxy resin, hydrobisphenol A epoxy resin, organic silicon-modified bisphenol A epoxy resin, saturated glycidic ester epoxy resin, heterocyclic and mixed epoxy resins or any combination thereof.

64. The mixture of claim 61, wherein said polyurethane resin comprises aliphatic polyols and polyisocyanates.

65. The mixture of claim 64, wherein said polyurethane resin is further added with a polyurethane curing reaction catalyst.

66. The mixture of claim 65, wherein said polyurethane curing reaction catalyst is lead naphthenate or dibutyltin dilaurate.

67. The mixture of claim 55, wherein said quartz sand is selected from aeolian sand in desert.
